(19) United States
(12) Patent Application Publication
(10) Pub. No.: US 2004/0010495 A1
(43) Pub. Date: Jan. 15, 2004

(54) Method and apparatus for limiting unauthorized copying of copyrighted works over the internet

(76) Inventors: Glenn W. Kramer, Houston, TX (US); Anthony R. Howlett, Spring, TX (US)

Correspondence Address: GARY L. BUSH, ANDREWS & KURTH, L.L.P., SUITE 4200, 600 TRAVIS, HOUSTON, TX, 77002, US

(21) Appl. No.: 10/600,225

(22) Filed: Jun. 20, 2003

Related U.S. Application Data
(60) Provisional application No. 60/390,454, filed on Jun. 21, 2002.

(51) Int. Cl. G06F 7/00

(52) U.S. Cl. 707/9

(57) ABSTRACT

A system and method which seeks out and identifies internet sites offering unauthorized downloading of copyrighted material, which makes multiple requests for the offerings from the identified sites to make it difficult or impossible for those seeking such illegal material to access the site, and which creates a number of internet sites which appear to offer the same copyrighted work to act as “red herrings” for a potential copyright infringer.

### CROSS REFERENCE TO RELATED APPLICATION

This application is based upon provisional application No. 60/390,454 filed on Jun. 21, 2002, the priority of which is claimed.

### BACKGROUND OF THE INVENTION

1. Field of the Invention

This invention generally concerns the practice of unauthorized copying of copyrighted works over the internet and specifically concerns a method and apparatus for decreasing the copying of copyrighted works made available under SWARM technology.

2. Description of the Prior Art

Unauthorized copying of copyrighted material works such as movies, music performances, books, software, audio books and others is rampant today because of software such as MORPHEUS. FIG. 1 illustrates the method and arrangement of a file sharing network 2 like MORPHEUS which uses a SWARM method to spread its downloads across multiple sites 10 and distributes its master index 12 so that users can find files anywhere on the network. The SWARM method uses dynamically assigned supernodes which identify Internet sites 10 where a work resides and is available for copying. A very large number of such sites exist, and when loaded with MORPHEUS software, a user 14 seeking a copyrighted work is automatically linked to the computer site 16 where the work resides as a digital file. That digital file is transmitted via the internet to the user's computer.

Such a system unfairly and illegally contributes to the unauthorized copying of copyrighted works due to two factors. The first is the ease of an illegal possessor 16 of a copyrighted work to register that work on the MORPHEUS data base 12. The second is the ease with which a person 14 seeking to copy a digital file of a copyrighted work can contact the owner 16 at his web site and download that digital file to his own computer.

3. Identification of Objects of the Invention

A primary object of the invention is to make multiple requests of a copyrighted work so as to overload the copying process by users seeking unauthorized copies of copyrighted works.

### SUMMARY OF THE INVENTION

The object identified above along with other advantages and features are achieved by an invention incorporated by a system called NEO™ (Trademark term for the system of this application) that seeks out and identifies Internet sites that offer unauthorized copying of copyrighted material. The NEO system then makes multiple requests for the offerings from the identified site, making it difficult or impossible for other users seeking such copyrighted material to assess the site and download it. The NEO system also creates a number of sites which appear to offer the same copyrighted work to act as “red herrings” for a potential copyright infringer.

Other features and advantages of the invention will become more apparent after referring to the following specification and drawings.

### BRIEF DESCRIPTION OF THE DRAWINGS

FIG. 1 is an illustration of prior art SWARM technology by which a user seeking a file for a copyrighted work is connected to a web site that offers that work and downloads same to his computer.

FIG. 2 is a schematic illustration of apparatus and communication links according to the invention, and

FIG. 3 is a schematic illustration of the method according to the invention.

### DESCRIPTION OF A PREFERRED EMBODIMENT OF THE INVENTION

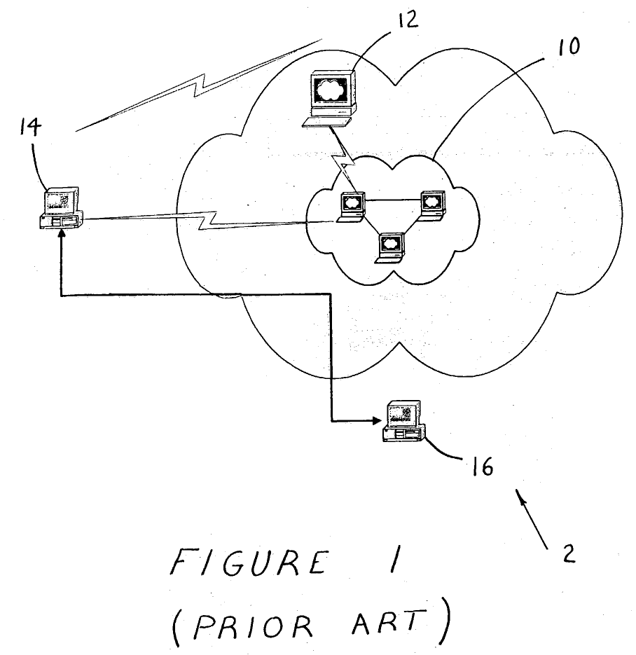

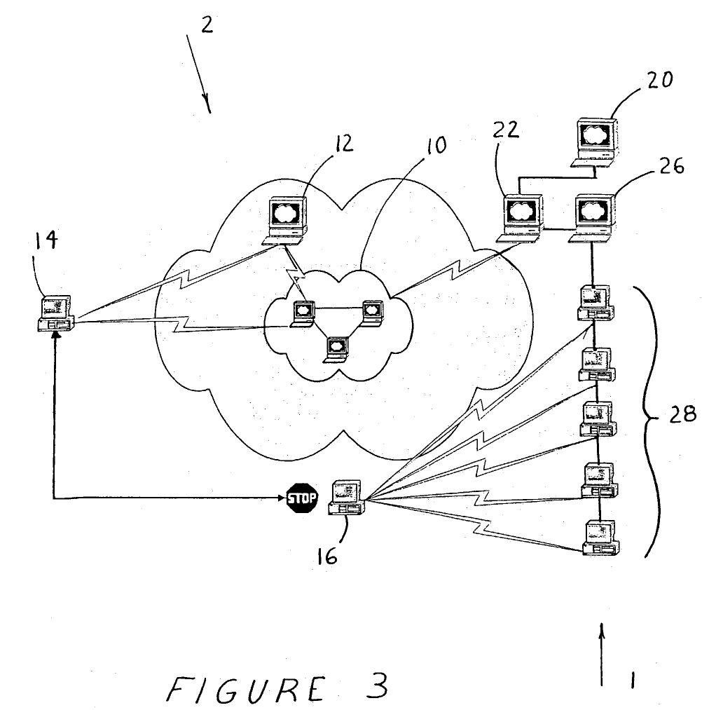

NEO's operation makes large scale Internet media piracy much more difficult. NEO uses concepts similar to those used by MORPHEUS and other file sharing programs that make themselves difficult to pinpoint and shutdown. MORPHEUS uses a “SWARM” technology to spread its downloads across multiple sites 10 and to distribute its master index 12 so that users can find files anywhere on the network (see prior art FIG. 1). NEO uses a new “Web of Anti-SWARM Programs” (WASP) technology to find and seek out instances of illegal copyrighted material and then initiate multiple downloads of that material. By legally using the MORPHEUS software for its intended purpose, i.e., to download copies of offered copyrighted material, NEO is capable of limiting unauthorized users' ability to gain access to that material (see FIG. 3). NEO uses the Internet that these technologies depend on against them.

NEO also can be used to create multiple apparent copies of the same material for download via these systems. However, users who access this material only get a message to visit the store or theatre to purchase the material in the proper way. Such links lead to an online site where owners of a copyrighted work might actually offer downloads of the material for a fee.

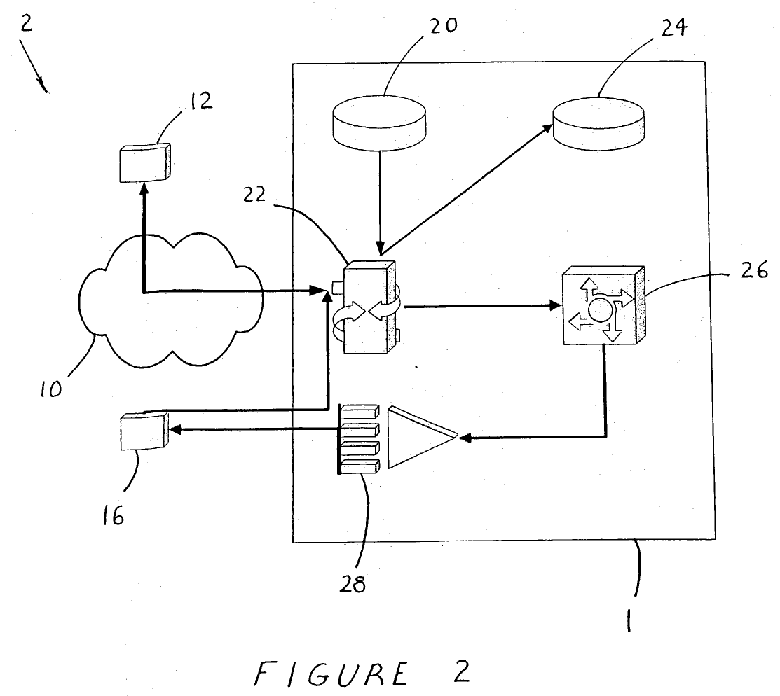

The NEO System 1 of FIG. 2 comprises of several interactive components that work to discourage casual Internet piracy of selected, copyrighted materials.

The NEO Protected Material Database 20 includes a list of all copyrighted works for which protection by inhibiting unauthorized copying is desired. The list includes the main names of the work as well as major characters/titles/names within the work so that subparts and derivatives of the work are protected as well. This database is hosted on a large scale PC-server.

The NEO Searcher program 22 is designed to make inquiries to super-nodes 10 of any targeted file-sharing network suspected of participating in offering or making unauthorized copies of any item contained in the NEO Protected Material Database 20. When NEO Searcher 22 discovers an instance of this offering, it initiates a download of this offered material to verify that it is, in fact, an actual substantial copy of the copyrighted work. If the material is verified as being an unauthorized copy, NEO Searcher 22 records the location of the user's IP address and stores downloaded material as well as the time and date of the action in the NEO Incident Tracker Database 24. Pertinent parts of this stored information are then forwarded to the NEO Scheduler 26.

Once the NEO Searcher 22 verifies an incidence of unauthorized use from a specific location 16, it is logged into the NEO Incident Tracker Database 24. This information is saved for later reference and documentation purposes in case of legal action.

The NEO Scheduler software 26 uses the data provided by NEO Searcher 22 to target the sites 10 offering the unauthorized material and schedules downloads of copyrighted material from those IP addresses that are offering it. The multiple downloads are scheduled randomly through the network of NEO Agents 28. (See FIG. 3)

NEO Agents 28 are computers that are spread in multiple locations throughout the Internet. Each agent uses software to change its IP address frequently so it cannot be identified or targeted. The NEO Agent 28 is indistinguishable from any other potential “client” for the requested unauthorized downloaded material. The NEO Agents 28 exist on multiple small servers of they can be concentrated in one large server with multiple IP addresses. Most NEO Agents 28 include high speed Internet connections, allowing the capture of the maximum amount of bandwidth from the targeted site.

NEO makes it very difficult for the casual user 14 of the many distributed file-sharing services 2 such as MORPH to download unauthorized copies of copyrighted material. By “filling the queue” with requests, NEO 1 preempts the great majority of those attempting to “get in line” to receive a copy. NEO's constant searching, identifying, logging and multiple requesting of many downloads disrupts and discourages the current epidemic of unauthorized Internet piracy.

While preferred embodiments of the present invention have been illustrated in detail, it is apparent that modifications and adaptations of the preferred embodiments will occur to those skilled in the art. It is to be expressly understood that such modifications and adaptations are in the spirit and scope of the present invention as set forth in the following claims:

What is claimed is:

1. A method of disrupting illegal copying of a copyrighted work over the internet comprising the steps of:
storing a characteristic of a copyrighted work to be protected in a first database,
searching the internet for the presence of said characteristic in a stored work in computer linked to the internet,
downloading by at least one agent computer said stored work from said computer linked to the internet,
verifying that said stored work is a copy of said copyrighted work, and
scheduling multiple downloads by said at least one agent computer of said stored work from said internet site.

2. The method of claim 1 further comprising the steps of,
logging into a second database the location of the internet protocol address of said stored work and the time and the date when said stored work was downloaded by said at least one agent computer, and
storing said downloaded stored work from said internet site into said second database.

3. The method of claim 1 further comprising the step of,
frequently changing the internet protocol address of said at least one agent computer.

4. A method of disrupting illegal copying of a copyrighted work over the internet comprising the steps of,
creating a decoy file of a copyrighted work to be protected,
storing said decoy file in at least one decoy computer,
registering a plurality of internet protocol addresses of said decoy file of said at least one decoy computer on a file sharing system as a host to provide said copyrighted work for downloading, and returning an indicator that said copyrighted work is not available for transfer from said decoy computer when a request for transfer of a copyrighted work is requested.

5. Apparatus for disrupting illegal copying of a copyrighted work over the internet comprising,
a first database for storing a characteristic of a copyrighted work to be protected,
a search engine linked to said first database for searching computers linked to the internet for the presence of an internet site with a stored work having said characteristic said copyrighted work,
at least one agent computer for downloading said stored work from said internet site, comparing said stored work to said copyrighted work to determine if said stored work is a copy, and
a scheduler linked to said at least one agent computer for directing said at least one agent computer to download said stored work from said internet site.

6. The apparatus of claim 5 further comprising,
a second database for storing information about said internet site.

7. The apparatus of claim 5 further comprising,
at least one decoy computer having a decoy file of said copyrighted work, said one decoy file location registered with a file sharing system as having said copyrighted work available for downloading.

8. The apparatus of claim 5 wherein said at least one agent computer is adapted to change its internet protocol address frequently.
